(19) United States
(12) Patent Application Publication
(10) Pub. No.: US 2015/0026519 A1
(43) Pub. Date: Jan. 22, 2015

(54) SERIAL ATTACHED SMALL COMPUTER SYSTEM INTERFACE EXPANDER AND DEBUGGING METHOD

(71) Applicant: HON HAI PRECISION INDUSTRY CO., LTD., New Taipei (TW)

(72) Inventors: CHIH-HUANG WU, New Taipei (TW); CHO-HAO WANG, New Taipei (TW)

(73) Assignee: HON HAI PRECISION INDUSTRY CO., LTD., New Taipei (TW)

(21) Appl. No.: 13/966,358

(22) Filed: Aug. 14, 2013

(30) Foreign Application Priority Data
Jul. 19, 2013 (TW) 102125867

(51) Int. Cl. G06F 11/263

(52) U.S. Cl. CPC G06F 11/2635
USPC 714/30

(57) ABSTRACT

A serial attached Small Computer System Interface (SAS) expander comprises a SAS expander chip which comprises a first debug port and a second debug port, a controlling chip which is in communication with the first debug port through a first serial port, in communication with the second debug port through a second serial port, and in communication with a host computer through a third serial port, once the controlling chip controls the third serial port to receive a debug command from the host computer, the controlling chip sends the received debug command to the first debug port or the second debug port according to a reference table.

### BACKGROUND

1. Technical Field

Embodiments of the present disclosure relate to device debugging technology, and more particularly to a serial attached Small Computer System Interface (SAS) expander and a debugging method of the SAS expander.

2. Description of Related Art

SAS expanders are widely used in the computer industry. Generally, the SAS expander has a first debug port and a second debug port, for a host computer to debug the SAS expander. However, it is inconvenient for a user to switch between the first debug port and the second debug port to connect the host computer manually. Therefore, a more efficient debugging method of the SAS expander is needed.

### BRIEF DESCRIPTION OF THE DRAWINGS

FIG. 1 is a block diagram of one embodiment of a SAS expander.

FIG. 2 is an example to illustrate a reference table that records a plurality of debug commands

FIG. 3 illustrates a flowchart of one embodiment of a debugging method of the SAS expander of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

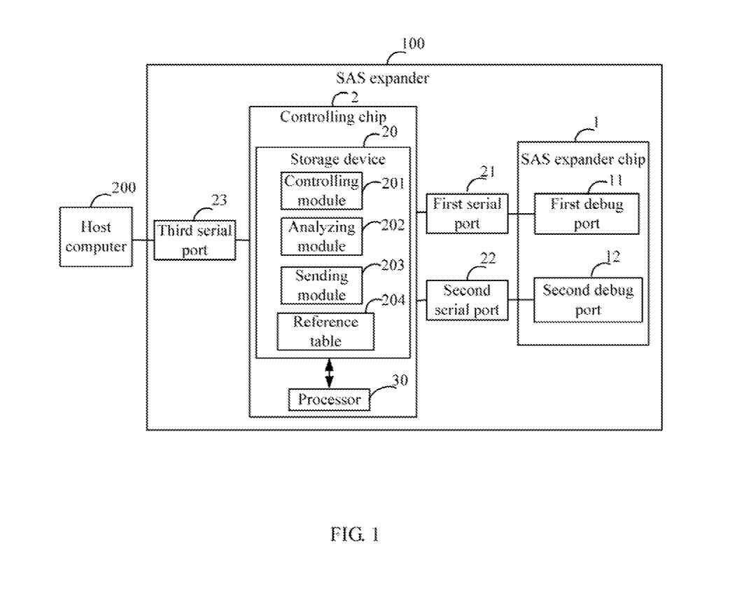

FIG. 1 is a block diagram of one embodiment of a serial attached Small Computer System Interface (SAS) expander 100. The SAS expander 100 includes an SAS expander chip 1, which includes a first debug port 11 and a second debug port 12.

A host computer 200 may use the first debug port 11 or the second debug port 12 to debug the SAS expander 100. In one embodiment, the host computer 200 may utilize the first debug port 11 to obtain a version, a status, and register information of the SAS expander chip 1. The host computer 200 may utilize the second debug port 12 to erase and update firmware of the SAS expander chip 1.

For example, when the host computer 200 debugs the SAS expander 100, the host computer 200 sends debug commands to a corresponding debug port (e.g., the first debug port 11 or the second debug port 12). If the host computer 200 needs to obtain the version of the SAS expander chip 1, the host computer 200 sends a debug command of obtaining the version of the SAS expander chip 1, to the first debug port 11. If the host computer 200 needs to erase the firmware of the SAS expander chip 1, the host computer 200 sends a debug command of erasing the firmware of the SAS expander chip 1, to the second debug port 12.

The SAS expander 100 further includes a controlling chip 2, a first serial port 21, a second serial port 22, a third serial port 23. The controlling chip 2 is in communication with the first debug port 11 through a first serial port 21, in communication with the second debug port 12 through a second serial port 22, and in communication with the host computer 200 through a third serial port 23. In one embodiment, the first serial port 21, the second serial port 22, and the third serial port 23 are general-purpose serial communication interfaces, including data transmission ports and data reception ports.

The controlling chip 2 includes a storage device 20 and at least one processor 30. In one embodiment, the storage device 20 is an electrically erasable programmable read-only memory (EEPROM). The storage device 20 stores a number of function modules. The function modules may include computerized codes in the form of one or more programs. The computerized code includes instructions that are executed by the at least one processor 30. In one embodiment, the number of function modules includes a controlling module 201, an analyzing module 202, and a sending module 203.

In one embodiment, the controlling chip 2 predetermines a plurality of debug commands corresponding to the first debug port 11 or the second debug port 12, according to configuration of the first debug port 11 and the second debug port 12. The controlling chip 2 further generates a reference table 204 to record the plurality of debug commands and the corresponding debug ports (e.g., the first debug port 11 or the second debug port 12). The controlling chip 2 stores the reference table 204 in the storage device 20.

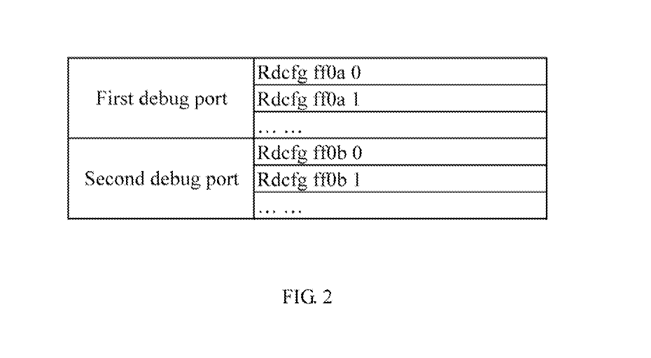

As an example, as shown in FIG. 2, the reference table 204 records the debug command of obtaining the version of the SAS expander chip 1 as “Rdcfg ff0a 0”, which corresponds to the first debug port 11. The reference table 204 further records a debug command of obtaining the register information of the SAS expander chip 1 as “Rdcfg ff0a 1”, which corresponds to the first debug port 11.

For another example, the reference table 204 records the debug command of erasing the firmware of the SAS expander chip 1 as “Rdcfg ff0b 0”, which corresponds to the second debug port 12. The reference table 204 further records a debug command of updating the firmware of the SAS expander chip 1 as “Rdcfg ff0b 1”, which corresponds to the second debug port 12.

The controlling chip 2 controls the third serial port 23 to receive the debug command from the host computer 200, and sends the received debug command to the first debug port 11 or the second debug port 12, according to the reference table 204. Details will be given in the following paragraphs.

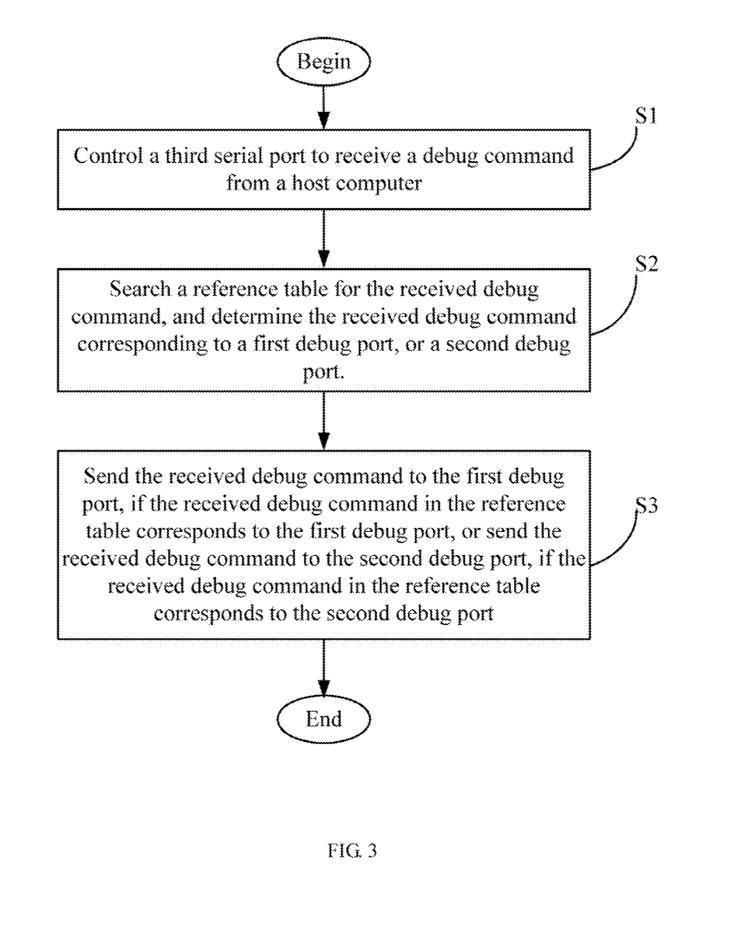

FIG. 3 illustrates a flowchart of one embodiment of a method of debugging the SAS expander of FIG. 1. Depending on the embodiment, additional steps in FIG. 3 may be added, others removed, and the ordering of the steps may be changed.

In step S1, the controlling module 201 controls the third serial port 23 to receive the debug command from the host computer 200. For example, the controlling module 201 controls the third serial port 23, to receive the debug command “Rdcfg ff0b 0” of erasing the firmware of the SAS expander chip 1.

In step S2, the analyzing module 202 searches the reference table 204 for the received debug command, and determines that the received debug command corresponding to the first debug port 11 or the second debug port 12 when the received debug command is found in the reference table 204. When the received debug command cannot be found in the reference table 204, the analyzing module 202 displays an error reminder to tell a user the received command does not exist in the referenced table 204.

For example, the analyzing module 202 searches the reference table 204 for the received debug command “Rdcfg ff0b 0”, and determines that the received debug command “Rdcfg ff0b 0” corresponds to the second debug port 12 according to the reference table 204. If the received debug command “Rdcfg ff0b 0” is not found in the reference table 204, the analyzing module 202 outputs an error message to a display or an audio device.

In step S3, the sending module 203 sends the received debug command to the first debug port 11 through the first serial port 21 if the received debug command in the reference table 204 corresponds to the first debug port 11, or sends the received debug command to the second debug port 12 through the second serial port 21 if the received debug command in the reference table 204 corresponds to the second debug port 12.

For example, the sending module 203 sends the received debug command “Rdcfg ff0b 0” to the second debug port 12, as the received debug command “Rdcfg ff0b 0” in the reference table 204 corresponds to the second debug port 12.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A serial attached Small Computer System Interface (SAS) expander, comprising:
a SAS expander chip which comprises a first debug port and a second debug port;
a controlling chip which is in communication with the first debug port through a first serial port, in communication with the second debug port through a second serial port, and in communication with a host computer through a third serial port;
a processor; and
a storage device storing a plurality of instructions, which when executed by the processor, causes the processor to:
control the third serial port to receive a debug command from the host computer using the controlling chip; and
send the received debug command to the first debug port or the second debug port using the controlling chip.

2. The SAS expander according to claim 1, wherein the first serial port, the second serial port, and the third serial port are general-purpose serial communication interfaces.

3. The SAS expander according to claim 1, wherein the received debug command is sent to the first serial port or the second serial port according to a reference table, which is predetermined by:
predetermining a plurality of debug commands, and each of the plurality of debug commands corresponding to the first debug port or the second debug port; and
generating the reference table to record the plurality of debug commands and the corresponding debug ports.

4. The SAS Expander according to claim 3, wherein the processor sends the received debug command to the first debug port through the first serial port using the controlling chip when the received debug command in the reference table corresponds to the first debug port; or sends the received debug command to the second debug port through the second serial port using the controlling chip when the received debug command in the reference table corresponds to the second debug port.

5. A method for debugging a serial attached Small Computer System Interface (SAS) expander, the SAS expander comprising a SAS expander chip which comprises a first debug port and a second debug port, a controlling chip which is in communication with the first debug port through a first serial port, in communication with the second debug port through a second serial port, and in communication with a host computer through a third serial port, the SAS expander further comprising a processor, the method comprising:
controlling the third serial port to receive a debug command from the host computer using the controlling chip; and
sending the received debug command to the first debug port or the second debug port using the controlling chip.

6. The method according to claim 5, wherein the first serial port, the second serial port, and the third serial port are general-purpose serial communication interfaces.

7. The method according to claim 5, wherein the received debug command is sent to the first serial port or the second serial port according to a reference table, which is predetermined by:
predetermining a plurality of debug commands, and each of the plurality of debug commands corresponding to the first debug port or the second debug port; and
generating the reference table to record the plurality of debug commands and the corresponding debug ports.

8. The method according to claim 7, wherein the received debug command is sent to the first debug port through the first serial port using the controlling chip, when the received debug command in the reference table corresponds to the first debug port; or the received debug command is sent to the second debug port through the second serial port using the controlling chip, when the received debug command in the reference table corresponds to the second debug port.

9. A non-transitory storage medium having stored thereon instructions that, when executed by a processor of a serial attached Small Computer System Interface (SAS) expander, causes the processor to perform debugging method in the SAS expander, the SAS expander comprising a SAS expander chip which comprises a first debug port and a second debug port, a controlling chip which is in communication with the first debug port through a first serial port, in communication with the second debug port through a second serial port, and in communication with a host computer through a third serial port, wherein the method comprises:
controlling the third serial port to receive a debug command from the host computer using the controlling chip; and
sending the received debug command to the first debug port or the second debug port using the controlling chip.

10. The non-transitory storage medium according to claim 9, wherein the first serial port, the second serial port, and the third serial port are general-purpose serial communication interfaces.

11. The non-transitory storage medium according to claim 9, wherein the received debug command is sent to the first serial port or the second serial port according to a reference table, which is predetermined by:
predetermining a plurality of debug commands, and each of the plurality of debug commands corresponding to the first debug port or the second debug port; and
generating the reference table to record the plurality of debug commands and the corresponding debug ports.

12. The non-transitory storage medium according to claim 11, wherein the received debug command is sent to the first debug port through the first serial port using the controlling chip, when the received debug command in the reference table corresponds to the first debug port; or the received debug command is sent to the second debug port through the second serial port using the controlling chip, when the received debug command in the reference table corresponds to the second debug port.
